(19) United States
(12) Patent Application Publication
(10) Pub. No.: US 2004/0092634 A1
(43) Pub. Date: May 13, 2004

(54) Anti-aging agents based on phenolic salts

(76) Inventors: Eric Arnoldi, Leverkusen (DE); Heinz-Peter Billigen, Dormagen (DE); Jorg Hagemann, Koln (DE); Hans-Rafael Winkelbach, Koln (DE); Ezio Campomizzi, Ontario (CA); Harald Bender, Koln (DE)

Correspondence Address: BAYER POLYMERS LLC, 100 BAYER ROAD, PITTSBURGH, PA, 15205, US

(21) Appl. No.: 10/702,868

(22) Filed: Nov. 6, 2003

Related U.S. Application Data
(62) Division of application No. 09/929,190, filed on Aug. 14, 2001.

(30) Foreign Application Priority Data
Aug. 16, 2000 (DE) 10039754.9

(51) Int. Cl. C08K 5/05

(52) U.S. Cl. 524/384

(57) ABSTRACT

The invention relates to anti-aging agents for organic polymers based on salts of sterically hindered phenolic compounds with at least two phenolic OH groups. The anti-aging agents according to the present invention display a significantly better anti-aging action than the sterically hindered phenolic compounds underlying the salts.

### FIELD OF THE INVENTION

The invention relates to anti-aging agents for organic polymers based on salts of sterically hindered phenolic compounds with at least two phenolic OH groups.

### BACKGROUND OF THE INVENTION

It is known to protect organic polymers, in particular rubber vulcanizates, against damaging external influences by means of anti-aging agents or anti-degradation agents. Aging in the organic polymers or rubber vulcanizates can become noticeable in very different ways, for example through hardening and embrittlement of the polymers, through the softening thereof, through the loss of the elastic properties and strength properties, through cracking, alteration of the surface or through other changes in properties, such as the electrical properties, or the appearance of unpleasant odors. Various aging processes are responsible for the stated changes and are described, for example, in the Handbuch fur die Gummi-Industrie, 2^{nd} fully revised edition, 1991, page 423 et seq (publisher: Bayer AG, sphere of business: rubber, application technology).

In order to prevent the aforementioned aging processes in the polymers, particularly in the rubber elastomers, it is known—as mentioned—to add anti-aging agents which for practical purposes are subdivided into three different classes of compounds: the monofunctional or oligofunctional secondary aromatic amines, the monofunctional or oligofunctional substituted phenols or the heterocyclic mercapto(-SH) compounds.

The known anti-aging agents are, however, still worth improving, particularly as far as their anti-aging protective action is concerned, especially in the case of high-temperature-loading polymers, particularly in the case of the rubber vulcanizates. It is to be noted that the known anti-aging agents clearly deteriorate in their action if the polymers to be protected are exposed to relatively high temperatures.

Furthermore, it is desirable that the anti-aging agents to be employed have no discoloring effect, for example when employed in rubber vulcanizates, and can be used in rubber mixtures together with peroxide or sulfur cross-linkers.

### SUMMARY OF THE INVENTION

It has now been found that anti-aging agents based on salts of sterically hindered phenolic compounds with at least two phenolic OH groups bring about a clear enhancement of the resistance to aging of organic polymers, in particular of rubber elastomers, without discoloring the polymers to be protected or reacting noticeably with peroxide or sulfur cross-linkers.

### DETAILED DESCRIPTION OF THE INVENTION

Therefore, the present invention provides anti-aging agents for organic polymers based on salts of sterically hindered phenolic compounds with at least two phenolic OH groups, which are obtained by reaction of basic metal salts and the phenolic compounds underlying the phenolic salts.

In a preferred embodiment of the invention, the basic salts are employed in hypostoichiometric quantities relative to the phenolic compounds.

In this embodiment, the basic metal salts are caused to react with the phenolic compounds in such a quantity that 5 to 95%, preferably 10 to 90%, more preferably 30 to 70%, and most preferably 40 to 60%, of the phenolic OH groups are converted.

As basic metal salts, the following may be considered, for example: the oxides, hydroxides, alcoholates, carbonates, bicarbonates and/or hydrides of the metals pertaining to Groups Ia, Ia, IIIa of the Periodic Table of the Elements (Mendeleev), but preferably the metals from the alkali and/or alkaline-earth groups. The following metals may be named, for example: zinc, sodium, potassium, magnesium and also calcium, preferably sodium, potassium and calcium.

A more preferred embodiment is the use of sodium hydroxide, potassium hydroxide, calcium hydroxide, calcium hydride, sodium methanolate, sodium ethanolate, sodium carbonate and/or potassium carbonate by way of basic metal compounds.

By way of sterically hindered phenolic compounds with at least two phenolic OH groups, in accordance with the present invention, those phenolic compounds may be considered, which in the course of salt formation are capable of forming electronically stabilized salt structures with the phenol substance, i.e. of guaranteeing a uniform distribution of the negative charge via resonance structures.

For example, sterically hindered phenolic compounds of the general formulae listed below can be used for the purpose of salt formation:

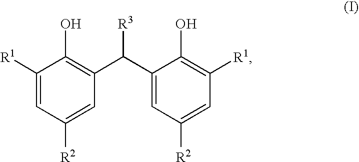

where

R¹, R² and R³ may be the same or different and

R¹, R² stand for a C₁-C₁₂ alkyl residue or C₅-C₈ cycloalkyl residue which may optionally be substituted by C₁-C₂ alkyl groups

and

R³ stands for hydrogen or a C₁-C₈ alkyl residue or C₅-C₆ cycloalkyl residue,

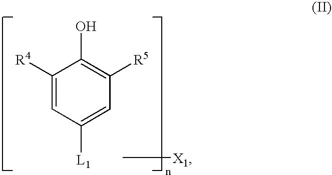

and also

where

R⁴ and R⁵ have the significance of the residue R¹ of formula (I),

L₁ stands for a C₂-C₁₂ alkyl residue which may be interrupted by or terminally substituted with

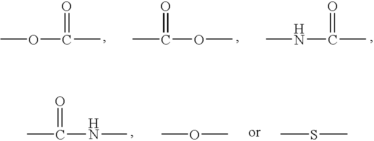

X₁ stands for —C(H)₄₋ₙ— or, in the case of n=2, also for —O— or —S—

and

n stands for 2, 3 or 4.

Examples of phenols that can be used in accordance with the invention are reproduced formulaically as follows:

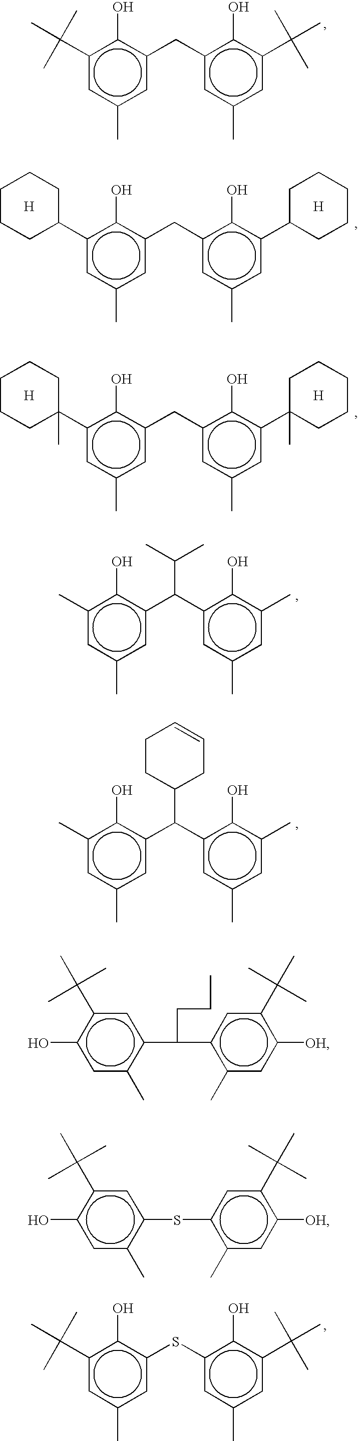

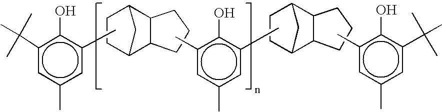

Mixture of compounds with n=0, 1, 2, 3 and 4,

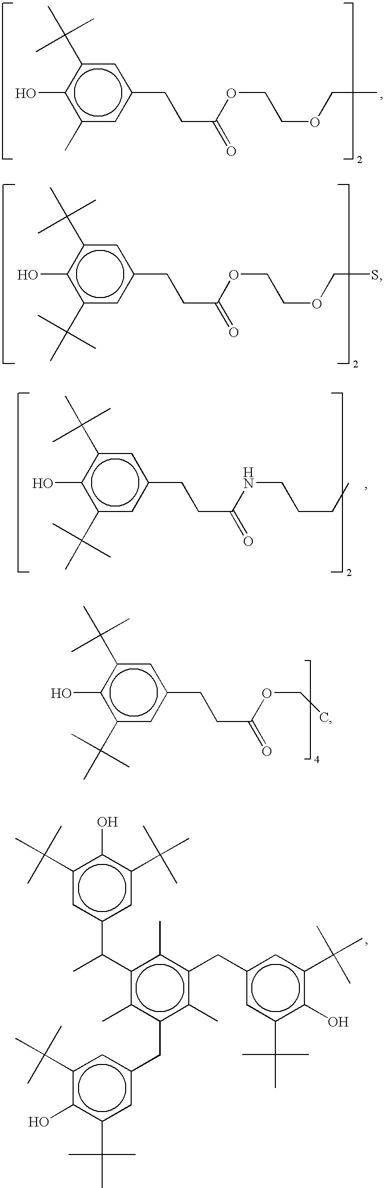

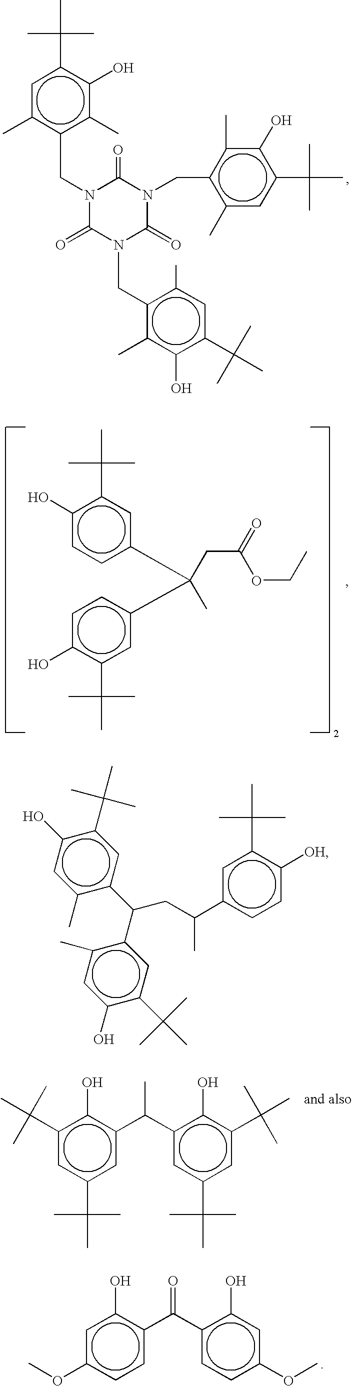

In a most preferred manner, the following are used as phenolic compounds:

2,2′-methylene-bis(4-methyl-6-alkylphenols) and also 2,2′-methylene -bis(4-methyl-6-cycloalkylphenols). In particular, the following are employed: 2,2′-methylene-bis(4-methyl-6-tert.-butylphenol) as well as 2,2′-methylene-bis(4-methyl-6-cyclohexylphenol).

As a result of the use of hypostoichiometric quantities of basic salts, in the course of the conversion of the named phenolic compounds, salts are obtained that still have a corresponding proportion of free hydrogen available from the phenolic OH groups.

The reaction of the named basic metal salts with the named phenolic compounds is usually carried out in such a way that the phenol is dissolved in an organic solvent, e.g. in an alcohol such as methanol or ethanol, and, subject to stirring, the basic metal salts or a solution of the same in the aforementioned solvent is slowly added. Then the solvent is distilled off in a vacuum, subject to gentle heating.

The temperatures in the course of the reaction lie within the range from −20 to 100° C., preferably 0 to 80° C. and most preferably from 20 to 60° C.

In particular, the basic metal salts are caused to react with the phenolic compounds in such a way that the salt of the phenolic compound is obtained directly as a result of a neutralization reaction of the basic metal salt with the acidic protons of the phenol compound.

Since the salts of the sterically hindered phenolic compounds that are obtained are frequently sensitive to atmospheric oxygen, moisture and also light, it is advisable to keep moisture and also atmospheric oxygen and light away from the salts that are obtained, by suitable measures such as inertization under nitrogen.

By reason of the delicate handling of the phenolic salts according to the present invention it is advisable, furthermore, to incorporate the phenolic salts, immediately after the preparation thereof, into the polymers or elastomers to be protected or to produce appropriate masterbatches which can then be incorporated as such into the organic polymers to be protected.

The concentration of the phenolic salts according to the present invention in mixtures usually amounts to 0.01 to 10wt. %, preferably 0.05 to 5 wt. %, relative to the organic polymer constituent.

A further method of preparation consists in the direct reaction of the phenol with the surface of an insoluble metal salt under elevated pressure up to 200 bar and at temperatures from 20 to 200° C. The salts of the sterically hindered, phenolic compounds that are obtained in this process prove to be insensitive to atmospheric oxygen, moisture and light and are therefore stable and processable for a longer period.

Of course, it is possible to blend the anti-aging agents according to the present invention based on salts of sterically hindered phenolic compounds with other, known anti-aging agents if this is desired. As anti-aging agents in this connection, may be considered, for example, those such as are described in the Lexikon der Kautschuk-Technik, 2^{nd} revised edition, Hüttig-Buch-Verlag, Heidelberg. Suitable, in particular, are p-phenyldiamine derivatives and diphenylamines.

The quantity of the known anti-aging agents to be added can easily be ascertained by appropriate preliminary tests and is dependent, inter alia, upon the end use of the organic polymers to be protected.

The anti-aging agents according to the present invention are suitable—as mentioned—in particular for use in rubber vulcanizates, in which case rubbers based on acrylonitrile copolymers and also ethylene-propylene-diene copolymers are preferred. Of course, the anti-aging agents according to the present invention can be employed—e.g. in the case where they are used in elastomers—together with the rubber auxiliaries and vulcanizing agents known for this purpose. As such, rubber auxiliaries and vulcanizing agents, the following may be named, for example: vulcanization accelerators and vulcanization retarders, metal oxides, sulfur, peroxidic compounds as well as fillers.

It is surprising that a clear improvement in the resistance to aging, for example in the case of rubber vulcanizates, was observed if salts of sterically hindered, phenolic compounds were employed that possessed at least two phenolic OH groups. Furthermore, such phenolic compounds displayed a clear enhancement of the resistance to aging, especially in the case of rubber vulcanizates, if the phenolic compounds were capable of stabilizing the negative charge—as mentioned—via resonance structures.

### EXAMPLES

### Example 1

### Preparation of the sodium salt of bis(3-tert.-butyl-2-hydroxy-5-methylphenyl)methylene (1)

300 g of absolute methanol is submitted and is freed of oxygen by applying vacuum and by ventilating with nitrogen. 170 g of bis(3-tert. -butyl-2-hydroxy-5-methylphenyl)methylene are dissolved in methanol. At RT there are added dropwise, within one hour, 90 g of a 30-% solution of sodium methylate in methanol. Stirring is allowed to continue for one hour, and the solvent is spun off completely at max. 40° C. 180 g of (1) are obtained as greyish beige solid.

### EXAMPLE 2

### Preparation of the calcium salt of bis(3-tert.-butyl-2-hydroxy-5-methylphenyl)methylene (2)

200 g of absolute methanol are submitted and are freed of oxygen by applying vacuum and by ventilating with nitrogen. 10.5 g of calcium-hydride powder are added and heated to reflux for about 30 min. Then, at RT subject to stirring, 85 g of bis(3-tert.-butyl-2-hydroxy-5-methylphenyl)methylene are added in portions. The suspension is stirred further for one hour and the solids are filtered off. 93 g of (2) are obtained as greenish beige solid.

### EXAMPLE 3

### Preparation of the sodium salt of bis(3-tert.-butyl-2-hydroxy-5-methylphenyl)methylene directly on sodium carbonate by a solid-solid reaction under elevated pressure and temperature (3)

For the experiment, use was made of an ASE (Accelerated Solvent Extraction) unit manufactured by Dionex. 1 g of Na carbonate (ground in the form of fine powder) is charged in an 11-ml extraction cell. Bis(3-tert. -butyl-2-hydroxy-5-methylphenyl)methylene is dissolved in n-hexane up until saturation (n-hexane solution over solids) and the solution is filtered off. The cell is brought to a temperature of 150° C., and 18 ml of the aforementioned saturated solution are conducted into the cell over the Na carbonate at an excess pressure of 50 bar for 10 min. The cell is flushed free with nitrogen and cooled. 1.2 g of (3) are obtained as beige solid.

For the assessment of the anti-aging agents according to the present invention, the latter are incorporated into appropriate rubber mixtures, and thin films for infrared measurements are cast from said rubber mixtures. In a hot-air oven at temperatures of 150° C. the mixture was subjected to an aging process and examined by means of infrared spectroscopy for oxidation products which have formed. Individual oxidation products were not examined, but rather the absorption in the infrared at the wave number 1,714 cm⁻¹ was utilized as being representative of carbon-oxygen compounds. To this end, at the aforementioned wave number the absorption was recorded and was normalized against a reference wavelength that is not subject to any influence due to oxidized products. For styrene-butadiene rubbers, by way of reference the absorption at 1,493 cm⁻¹ was utilized, for example. This normalized value was evaluated as the degree of oxidation. For the individual polymers, characteristic degrees of oxidation were defined as limits, and the time in the hot-air oven until this degree of oxidation was reached was measured.

Use was made of simplified rubber mixtures for the simplified experiments in the hot-air oven with infrared evaluation. In this connection, in each instance a limiting value for the oxidation was fixed as the ratio of the absorption of the oxidation products at 1,714 cm⁻¹ to the internal standard. The rubber mixtures that were employed consisted of a mixture of elastomer, a peroxide and the anti-aging agent to be examined.

For the experiments with hydrated acrylonitrile-butadiene rubber, a polymer was chosen having an acrylonitrile content of 34%. Use was made of Therban A3407, which is manufactured by Bayer AG and commercially available. The mixture contains, in detail, of

| | |
|---|---|
| Therban A3407 | 100 phr |
| p-methyl hydroperoxide | 6.5 phr |

various anti-aging agents in constant proportions

With these mixtures, aging processes were carried out as far as the oxidation ratio 0.2. The longer the mixtures hold out up until this time, the better the anti-aging protection.

TABLE 1

| | Aging at 150° C. |
|---|---|
| Additive | in hours |
| No additive | 102 |
| 2,2′-methylene-bis(4-methyl-6-tert.-butylphenol) | 571 |
| (BPH) | |
| Sodium salt of bis(3-tert.-butyl-2-hydroxy-5- | 1033 |
| methylphenyl)methylene | |
| 2,2′-methylene-bis(4-methyl-6-tert.-butylphenol) | 1360 |
| BPH) + 2 phr CaCO₃ | |
| Sodium salt of bis(3-tert.-butyl-2-hydroxy-5- | 1896 |
| methylphenyl)methylene on Na₂CO₃ | |

In the case of a further aging as far as the oxidation ratio of 0.4, the following results arise

TABLE 2

| | Aging at 150° C. |
|---|---|
| Additive | in hours |
| No additive | 145 |
| 2,2′-methylene-bis(4-methyl-6-tert.-butylphenol) | 764 |
| (BPH) | |
| Sodium salt of bis(3-tert.-butyl-2-hydroxy-5- | 1150 |
| methylphenyl)methylene | |
| 2,2′-methylene-bis(4-methyl-6-tert.-butylphenol) | 1440 |
| BPH) + 2 phr CaCO₃ | |
| Sodium salt of bis(3-tert.-butyl-2-hydroxy-5- | 2442 |
| methylphenyl)methylene on Na₂CO₃ | |

As expected, the unstabilized samples age most quickly. In second place comes the mixture with the mixture that had been provided, according to the state of the art, with the standard commercial anti-aging agent BPH. Unexpectedly, the salts of the phenols that were produced display significantly prolonged shelf-lives. The retardation of the aging becomes especially clear in the case of longer aging processes. Here, in the case of aging as far as the oxidation ratio of 0.4, surprisingly a retardation of the aging by a factor of three arises.

For the experiments with acrylonitrile-butadiene rubber, a polymer having an acrylonitrile content of 18% was chosen. Use was made of Perbunan NT 1845, which is manufactured by Bayer AG and commercially available. The mixture contains, in detail, of

| | |
|---|---|
| Perbunan NT 1845 | 100 phr |
| p-methyl hydroperoxide | 6.5 phr |
| anti-aging agent | |

With these mixtures, aging processes as far as the oxidation ratio 1.0 were carried out. The longer the mixtures hold out up until this time, the better the anti-aging protection.

TABLE 3

| | Aging at 150° C. |
|---|---|
| Additive | in hours |
| No additive | 247 |
| Sodium salt of bis(3-tert.-butyl-2-hydroxy-5- | 317 |
| methylphenyl)methylene on Na₂CO₃ | |

Unexpectedly, the mixture that was added to the salt of phenol that was produced displays a significantly prolonged shelf-life.

For the experiments with vinyl-butadiene-styrene rubber, a polymer having a styrene content of 25% was chosen. Use was made of Buna VSL 2525, which is manufactured by Bayer AG. The mixture contains, in detail, of

| | |
|---|---|
| Buna VSL 2525 | 100 phr |
| p-methyl hydroperoxide | 6.5 phr |
| anti-aging agent | |

With these mixtures, aging processes as far as the oxidation ratio 0.9 were carried out. The longer the mixtures hold out up until this time, the better the anti-aging protection.

TABLE 4

| | Aging at 150° C. |
|---|---|
| Additive | in hours |
| No additive | 62 |
| Sodium salt of bis(3-tert.-butyl-2-hydroxy-5- | 290 |
| methylphenyl)methylene on Na₂CO₃ | |

Unexpectedly, the mixture that was added to the salt of phenol that was produced displays a significantly prolonged shelf-life.

In the claims:

1. Anti-aging agents for organic polymers comprising salts of sterically hindered phenolic compounds with at least two phenolic OH groups, which are obtained by reaction of basic metal salts and the phenolic compounds underlying the phenolic salts.

2. Anti-aging agents according to claim 1, wherein the oxides, hydroxides, carbonates, bicarbonates, alcoholates and/or hydrides of the metals pertaining to Groups Ia, Ia, IIIa of the Periodic Table of the Elements are used as basic metal salts.

3. Anti-aging agents according to claim 1, wherein said phenolic compounds are of formulae (I) and (II): 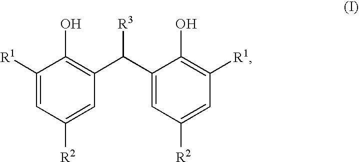
where
R¹, R² and R³ may be the same or different and
R¹, R² represents a C₁-C₁₂ alkyl residue or C₅-C₈ cycloalkyl residue which may optionally be substituted by C₁-C₁₂ alkyl groups
and
R³ represents hydrogen or a C₁-C₈ alkyl residue or C₅-C₆ cycloalkyl residue,
and also 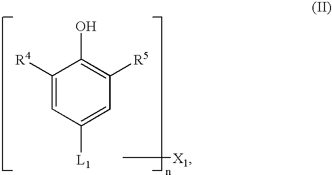
where
R⁴ and R⁵ have the significance of the residue R₁ of formula (I),
L₁ represents a C₂-C₁₂ alkyl residue which may be interrupted by or terminally substituted with 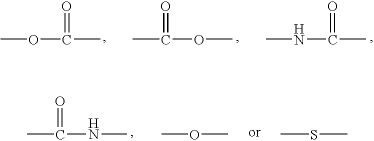
X₁ represents —C(H)₄₋ₙ— or, in the case of n=2, also for —O— or —S—
and
n represents 2, 3 or 4.

4. Anti-aging agents according to claim 1, wherein 5 to 95% of the phenolic OH groups of the phenolic compound react with the basic salts.
